(19) United States
(12) Patent Application Publication
(10) Pub. No.: US 2013/0227627 A1
(43) Pub. Date: Aug. 29, 2013

(54) ELECTRONIC SYSTEM COMPRISING MEANS FOR COMPUTING PERSONALIZATION PARAMETERS OF DATA TO BE REPRODUCED AND MEANS FOR SELECTING DATA TO BE REPRODUCED AS A FUNCTION OF SAID PARAMETERS, ASSOCIATED LOCAL DATA TRANSMISSION NETWORK AND SELECTION METHOD OF DATA TO BE REPRODUCED

(71) Applicant: MYRIAD GROUP AG, (US)

(72) Inventor: Christophe DELACHANAL, LUMBIN (FR)

(73) Assignee: MYRIAD GROUP AG, Zurich (CH)

(21) Appl. No.: 13/775,062

(22) Filed: Feb. 22, 2013

(30) Foreign Application Priority Data
Feb. 24, 2012 (FR) 12 51712

(51) Int. Cl. H04N 21/414; H04N 21/643

(52) U.S. Cl. CPC H04N 21/414; H04N 21/64322
USPC 725/110; 725/133

(57) ABSTRACT

This electronic system, comprises: a first electronic device comprising means for reproducing audio and/or video data; a second electronic device comprising means for transmitting data to be reproduced to the first device; and a third electronic device, connected to the second device and comprising a memory to store personal information associated with a user of the third device. The third device comprises means for computing personalization parameters of the data to be reproduced, based on the personal information, and means for transmitting the computed personalization parameters to the second device, without any transmission of the personalization parameters via the Internet network. The second device comprises means for selecting data to be reproduced in relation to the received personalization parameters, the selecting means being connected to the transmission means.

### BACKGROUND OF THE INVENTION

The present invention concerns an electronic system comprising:

a first electronic device, the first electronic device comprising audio and/or video data reproduction means;

a second electronic device, the second electronic device being connected to the first electronic device via a first data link, and comprising means for transmitting data to be reproduced to the first device; and

a third electronic device, the third electronic device being connected to the second electronic device via a second data link, and comprising a memory capable of storing personal information associated with a user of the third device.

The invention also concerns a local data transmission network comprising a said electronic system.

The invention further concerns a method for selecting data to be reproduced via an electronic device.

An electronic system of the aforementioned type is known. The first electronic device is a television and the second electronic device is a set-top box. The third electronic device is an item of portable electronic equipment such as a mobile telephone or a pad, preferably a smartphone. The third device is generally connected to the second device via a wireless data link such as a link conforming to standard IEEE 802.11 also known as the Wi-Fi™ standard. The third device is used in particular for the remote control of some functions of the set-top box.

The set-top box is firstly connected to the television via a wire connection for the transmission of audio and video data, and secondly to the Internet network. The set-top box transmits audio and/or video media to the television for the sound and/or visual reproduction thereof, these audio and/or video media being stored in a local hard disk or downloaded from the Internet network.

The user chooses the audio and/or video medium it is desired to listen to or watch on the television, via a man-machine interface directly managed by the set-top box. The set-top box enables the user to personalize the man-machine interface displayed on the television screen. Some media servers connected to the Internet network and offering audio and/or video media to be downloaded, also comprise a personalization filter so as only to offer the user those audio and/or video media related to the user's own personal parameter settings.

However, the user generally sets initial parameters for a said personalization filter and thereafter no longer changes these parameters, which means that the selection made of audio and/or video media is not optimal and does not always correspond to the user's current tastes.

### SUMMARY OF THE INVENTION

It is therefore the objective of the invention to provide an electronic system with which it is possible to improve the selection of data to be reproduced by the first device, whilst offering improved security for user personal data associated with this selection.

For this purpose, the subject-matter of the invention is an electronic system of the aforementioned type, characterized in that the third electronic device also comprises means for computing personalization parameters for the data to be reproduced, from personal information, and means for transmitting the computed personalization parameters to the second electronic device, without any transmission of personalization parameters via the Internet network, and in that the second electronic device also comprises means for selecting data to be reproduced in relation to the personalization parameters retrieved from the third electronic device, the selection means being connected to the transmission means to transmit the selected data to be reproduced to the first device.

According to other advantageous aspects of the invention, the electronic system comprises one or more of the following characteristics taken alone or in any possible technical combination:

the third electronic device further comprises means for making secure the user's personal information in the memory of the third device;

the user's personal information is stored in the memory of the third device and is not transmitted outside the third electronic device;

the data to be reproduced comprises elements of a man-machine interface, preferably stored in a memory of the second electronic device, without any transmission of the said elements of the man-machine interface via the Internet network;

the selecting means are able to select data relating to an electronic television program guide, so as only to present the user with television programs which relate to the user's personal information;

the electronic system comprises an electronic appliance comprising a box, and the first electronic device and the second electronic device are grouped together in the box of the electronic appliance;

the third electronic device is a mobile telephone, preferably a smartphone; and

the first electronic device is a television, and the second electronic device is a set-top box.

A further subject of the invention is a local data transmission network, characterized in that it comprises an electronic system such as defined above, in that each of the first and second data links is a wire or wireless short-distance communication link, such as a link having a length of less than 100 meters, and in that the transmission means are capable of sending the computed personalization parameters to the second electronic device without any transmission of the personalization parameters outside the local network.

According to another advantageous aspect of the invention, the local network has the following feature:

the short-distance wireless link is a link chosen from among the group formed by: a wireless link conforming to standard IEEE 802.11, a wireless link based on standard IEEE 802.15.1, and a wireless link conforming to standard IEEE 802.15.4.

A further subject of the invention is a method for selecting audio and/or video data to be reproduced by a first electronic device comprising means for reproducing audio and/or video data, the method comprising the following steps:

selecting, by a second electronic device, the data to be reproduced by the first device;

transmitting the selected data to the first device for reproduction thereof by the first device,

the method being characterized in that it also comprises the following steps:

computing, via a third electronic device, the personalization parameters for the data to be reproduced, from a user's personal information, the said personal information being stored in a memory of the third device; and

transmitting the computed personalization parameters to the second electronic device, without any transmission of the personalization parameters via the Internet network, the selection of data to be reproduced being made in relation to the personalization parameters received from the third electronic device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention will be better understood upon reading the following description, provided solely as an example, and done in reference to the appended drawings, in which:

FIG. 1 is a schematic illustration of an electronic system according to the invention; and

FIG. 2 is a flow chart of a selection method according to the invention.

### DETAILED DESCRIPTION

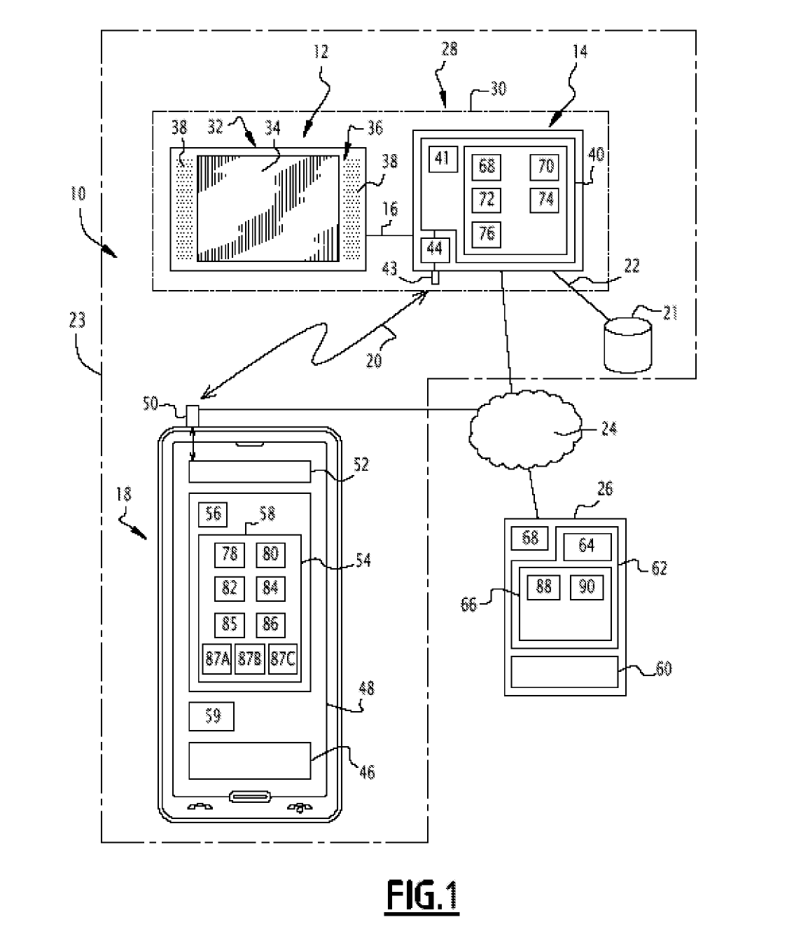

In FIG. 1 an electronic system 10 comprises a first electronic device 12, a second electronic device 14 connected to the first electronic device via a first data link 16, and a third electronic device 18 connected to the second electronic device 14 via a second data link 20.

In addition, the electronic system 10 comprises a data storage device 21 connected to the second electronic device 14 via a third data link 22.

For example, the electronic system 10 forms a local data transmission network 23 when each of the first, second and even third data links 16, 20, 22 is a wire or wireless, short-distance communication link, such as a link having a length of less than 100 meters. The first link 16 and the third link 22 are then preferably wire links, and the second link 20 is preferably a short-distance wireless link.

The short-distance wireless link conforms to standard IEEE 802.11, also called the Wi-Fi™ standard. Alternatively, the short-distance wireless link is a ZigBee® link based on standard IEEE 802.15.1, or a wireless link conforming to standard IEEE 802.15.4, also called the Bluetooth® standard.

The electronic system 10 is connected to the Internet network 24, and is connected via the Internet network 24 to a computerised server 26 managing audio and/or video media.

In the example of embodiment in FIG. 1, the first electronic device 12 and the second electronic device 14 are independent of each other and each have their own box.

Alternatively, the electronic system 10 comprises an electronic appliance 28 represented by the dotted line in FIG. 1, the electronic appliance 28 comprising a box 30 inside which the first electronic device 12 and the second electronic device 14 are grouped together.

The first electronic device 12 comprises video reproducing means 32 formed by a display screen 34 for example, and means, not illustrated, for displaying data on the screen. The first electronic device 12 comprises audio reproducing means 36 comprising loud speakers 38.

For example, the first electronic device 12 is a television.

The second electronic device 14 comprises a first data processing unit 40 formed by a first processor 41 for example associated with a first memory 42.

The second electronic device 14 comprises a first wireless antenna 43 and a first wireless transmitter-receiver 44.

The second electronic device 14 is a set-top box for example also known as a decoder.

The first data link 16, in the example of embodiment in FIG. 1, is a wire link, such as a data link conforming to the HDMI standard (High Definition Multimedia Interface). Alternatively, the first data link 16 is a wireless link, preferably a short-distance wireless link such as defined above.

The third electronic device 18 comprises data entry means 46, a display screen 48 associated with means, not illustrated, for displaying data on the screen.

The third electronic device 18 comprises a second wireless antenna 50 and a second wireless transmitter-receiver 52.

The third electric device 18 also comprises a second data processing unit 54 formed for example by a second data processor 56 associated with a second memory 58.

The third electronic device 18 additionally comprises geographical positioning means 59 such as a GPS module (Global Positioning System).

The third electronic device 18 is a mobile telephone for example, preferably a smartphone. Alternatively, the third electronic device 1 is a pad such as a touch pad.

The second data link 20, in the example of embodiment in FIG. 1, is a wireless link preferably a short-distance wireless link such as defined above. Alternatively, the second data link 20 is a wire data link.

The data storage device 21 comprises a hard disk capable of storing audio and/or video data. Alternatively or in addition, the data storage device 21 comprises a rewrite semiconductor mass storage memory also called a flash memory.

In the example of embodiment in FIG. 1, the data storage device 21 is independent of the first device 12 and of the second device 14. Alternatively, the data storage device 21 is independent of the electronic appliance 28.

Alternatively, the data storage device 21 is integrated in the first device 12 or in the second device 14. Alternatively, the data storage device 21 is integrated in the electronic appliance 28.

The data storage device 21 is a networked storage device for example also called a NAS device for Network Attached Storage, associated with the local network 23. The data storage device 21 is then capable of providing services across the local network 23 in IP mode (Internet Protocol), in accordance with one or more protocols from among the CIFS (Common Internet File System), NFS (Network File System) and AFP (Apple Filing Protocol) protocols.

The media managing server 26 comprises a database 60 and a data processing unit 62 formed by a third processor 64 for example associated with a third memory 66. The media managing server 26 also comprises means 68 for transmitting data over the Internet network and for receiving data from the Internet network.

The electronic appliance 28 is a smart TV for example which integrates the first and second electronic devices 12, 14.

The first memory 42 is capable of storing software 68 to transmit data to be reproduced to the first device 12, and software 70 to select data to be reproduced in relation to the personalization parameters received from the third device 18, the selection software 70 being coupled with the transmission software 68 to transmit the selected data to be reproduced to the first device 12.

Alternatively, the transmission means 68 and the selecting means 70 are in the form of programmable logic circuits or dedicated integrated circuits. The selecting means 70 are connected to the transmission means 68 to transmit the selected data to be reproduced to the first device 12.

The first memory 42 is also capable of storing software 72 for downloading data from the Internet network, such as audio and/or video data to be reproduced on the first device 12, the said data being downloaded for example from the managing server 26 through the Internet network 24. The first memory 42 is also capable of storing software 74 for sending data to the Internet network 24.

The first memory 42 is also able to store elements 76 of a man-machine interface without any transmission of the said elements of the man-machine interface 76 via the Internet network, the elements of the man-machine interface 76 being part of the data to be reproduced.

The first wireless antenna 43 and the first wireless transmitter-receiver 44 conform to a short-distance communication standard, this being chosen for example from the group comprising: the IEEE 802.11 standard, the ZigBee® protocol based on standard IEEE 802.15.1 and standard IEEE 802.15.4.

The data entry means 46 comprise a keypad. The keypad is a touch pad for example formed of keys displayed on the screen 48 if the display screen 48 is a touch screen. Alternatively, the keypad is a mechanical keypad.

The second wireless antenna 50 and the second wireless transmitter-receiver 52 also conform to a short-distance communication standard, chosen for example from the group comprising: standard IEEE 802.11, the ZigBee® protocol based on standard IEEE 802.15.1, and standard IEEE 802.15.4.

The second wireless antenna 50 and the second wireless transmitter-receiver 52 also conform to one or more mobile telephony standards such as the GSM standard (Global System for Mobile communications), GPRS standard (General Packet Radio Service) and/or UMTS standard (Universal Mobile Telecommunication System).

The second memory 58 is capable of storing software 78 to receive data via the wireless transmitter-receiver 52 from the second device 14 or from the Internet network 24, and software 80 for transmitting data via the wireless transmitter-receiver 52 to the second device 14 or to the Internet network 24.

The second memory 58 is capable of storing personal information 82 associated with a user of the third device 18. The personal information 82 is derived from data entered by the user using the data entry means 46, and/or from messages received by the user via the receiving software 78 and/or from global positioning data received from the global positioning means 59. In addition or alternatively, the personal information 82 is derived from data recorded by a Web navigator of the third device 18, and/or from data relating to lists of audio and/or video files chosen by the user (playlists).

The second memory 58 is also able to store computing software 84 to compute personalization parameters 85 of data to be reproduced, from the personal information 82.

The second memory 58 is also able to store software 86 to make secure the personal information 82 held in the memory 58 of the third device.

Alternatively or in addition, the second memory 58 is intended to receive learning data 87A, in particular data flows such as RSS flows (Really Simple Syndication). The data flows are regularly updated, and the learning data 87A stored in the second memory 58 is regularly updated.

The second processor 56 is able, via successive iterations, to perform a definition algorithm 87B, recorded in the second memory 58, to determine a classification algorithm 87C in relation to the learning data 87A received and stored in the second memory 58, the classification algorithm 87C being capable of classifying the personal information 82 into N categories, where N is an integer of 2 or higher, as will be described in more detail in the remainder hereof.

Alternatively, the learning data 87A and the definition algorithm 87B are stored in a memory of a fourth electronic device, not illustrated, and separate from the third device 18, such as a remote computer server. The fourth electronic device comprises a processor associated with a memory and is connected to the third device 18, for example via the Internet network 24. The fourth device such as the remote computer server is then capable, via successive iterations, of carrying out the definition algorithm 87B saved in its memory to determine the classification algorithm 87C in relation to the learning data 87A received by the server and stored in its memory. The classification algorithm 87C is then able to be transmitted to the third device 18 via the Internet network 24, so that it can be stored in the second memory 58. In other words, according to this alternative, among the learning data 87A, the definition algorithm 87B and the classification algorithm 87C, only the classification algorithm 87C is able to be stored in the second memory 58, after having been determined by the fourth device containing the learning data 87A and the definition algorithm 87B.

The database 60 is intended to store audio and/or video data with no particular selection of the said data.

The third memory 66 is capable of storing software 88 to receive a request to download audio and/or video data made by another electronic device such as the second electronic device 14, and software 90 to send audio and/or video data to the electronic device which transmitted the corresponding request.

The transmission software 68 is capable of transmitting the data to be reproduced and selected by the software 70 to the first device 12 for reproduction thereof via the video reproduction means 32 and/or the audio reproduction means 36.

The selection software 70 is able to select the data to be reproduced in relation to the personalization parameters 85 received from the third device 18.

The selection software 70 is capable for example of selecting data relating to an electronic television program guide known as EPG (Electronic Program Guide), so as only to present the user with television programs related to the user's personal information 82.

Alternatively or in addition, the selection software 70 is able to select audio and/or video data files from the personalization parameters 85 computed by the computing software 84 and from a list, not illustrated, of audio and/or video files contained in the storage device 21 and/or in the database 60, this list of files being stored in the second memory 42. The selection software 70 then allows the user to be presented only with those audio and/or video files which relate to the user's personal information 82 i.e. related to own personal tastes.

The download software 72 is capable of downloading data from the storage device 21 locally or from the database 60 via the Internet network 24, in particular data to be reproduced corresponding to a selection made by the selection software 70.

The transmission software 80 is able to transmit the personalization parameters computed by the computing software 84 to the second electronic device 14, without any transmission of the personalization parameters via the Internet network 24.

In the example of embodiment in FIG. 1 in which the first device 12, the second device 14, the third device 18 and the storage device 21 form the local network 23, the transmission software 80 is capable of sending the personalization parameters computed by the computing software 84 to the second electronic device 14, without any transmission of the personalization parameters outside the local network 23.

The user's personal information 82 is preferably stored in the memory 58 of the third device, and is not transmitted outside the third electronic device 18.

The computing software 84 is capable of computing the personalization parameters 85 from the personal information 82.

The personalization parameters 85 are computed for example by the computing software 84 in relation to localising personal information, the third device 18 being capable of storing localising personal information in its memory 58. Localising personal information is determined by the global positioning means 59 and corresponds to the different places where the user equipped with the third electronic device 18 has been to previously.

Alternatively or in addition, the personalization parameters 85 are computed by the computing software 84 from the personal information 82 and using the classification algorithm 87C.

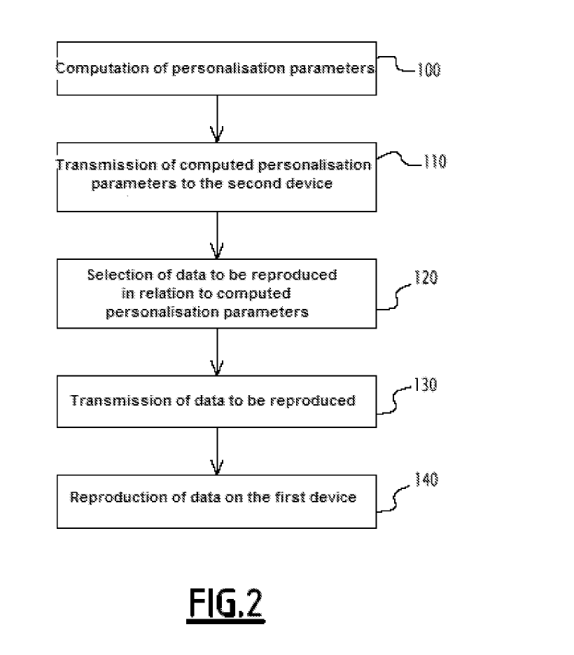

The functioning of the electronic system 10 will now be explained with the aid of FIG. 2 illustrating a flow chart of the method for selecting audio and/or video data to be reproduced via the first electronic device 12.

At an initial step 100, the personalization parameters 85 are computed by means of the computing software 84.

The personalization parameters 85 are associated for example with the localising personal information determined by the global positioning means 59 and allowing data to be selected corresponding to places to which the user has previously been.

Alternatively or in addition, the personalization parameters 85 are computed by the software 84 from the personal information 82 and using the classification algorithm 87C.

The preparation of the classification algorithm 87C will now be described in more detail. Let us consider N determined categories cat1_{CL1}, cat2_{CL1} . . . catN_{CL1} of a classification CL1.

For example, classification CL1 comprises the N=3 following categories: <<child>>, <<adult>>, <<senior>>. In another example, the classification CL1 comprises the N=6 following categories: <<football enthusiast>>, <<golf enthusiast>>, <<cycling enthusiast>>, <<tennis enthusiast>>, <<enthusiast of other sports>>, <<not a sports enthusiast>>. In another example, the classification CL1 comprises the N=4 following categories: <<football enthusiast>>, <<golf enthusiast>>, <<cycling enthusiast>>, <<tennis enthusiast>>.

When it is desired to determine whether each of the batches of learning data 87A received and stored in the second memory 58 comes under a determined category from among these N categories, a definition phase of the classification algorithm 87C is first initiated.

For each of the categories cat1_{CL1}, cat2_{CL1} catN_{CL1}, a sample of data flows is formed identified as belonging to this category, and the data of each flow is regularly updated.

For example, the number of data flows in each sample is higher than 100.

Next, from each of these learning data items 87A, the definition algorithm 87B models the classification algorithm 87C as per the categories cat1_{CL1}, cat2_{CL1} . . . catN_{CL1}.

The definition algorithm 87B thereby constructs the classification algorithm 87C with the help of a learning mechanism from these learning data 87A whose category is known.

The definition algorithm 87B is of genetic programming type for example, or an inverse propagation method, a fuzzy classifier, Bayesian network, neural network (see for example McCallum, A. and Nigam K. “A Comparison of Event Models for Naive Bayes Text Classification”. In AAAI/ICML-98 Workshop on Learning for Text Categorization, pp. 41-48. Technical Report WS-98-05. AAAI Press. 1998; Prinzie, A., Van den Poel, D. (2008). Random Forests for multiclass classification: Random MultiNomial Logit, Expert Systems with Applications, 34(3), 1721-1732).

As ad when new learning data 87A are collected, the definition algorithm 87B is reiterated by fine-tuning and completing the rules defining the classification algorithm 87C in particular as a function of these new data and optionally of previously collected data, for example for as long as the classification algorithm 87C allocates collected data corresponding to a category given by the N categories to a category different from the given category (or for as long as the rate of data classification error by the classification algorithm 87C is higher than a determined threshold).

The classification algorithm 87C is therefore constructed iteratively, dynamically, as and when new data are collected.

This algorithm is adapted to determine, in relation to the data provided as input data, whether the data derives from a batch of data coming under a category from among the categories cat1_{CL1}, cat2_{CL1} . . . catN_{CL1}, and to indicate which category.

The rules included in the classification algorithm 87C comprise the detection for example of certain target words and decision trees combining detected words and/or the non-detection of words by logic functions (AND, OR, AND NOT, CLOSE TO, etc.)

For example, a decision tree to determine whether the data refer to football could be: <<IF (WORD goal) AND ((WORD striker) or (WORD corner)) IS IN DATA=>THEN THE DATA REFER TO FOOTBALL>>.

Said method therefore gives rise to a classification program of small size which can be run on devices having reduced computing and memory sources, but which is nevertheless most efficient.

For example, about one hundred algorithmic rules capable of detecting a football text will only require 100*(50 bytes)=5000 bytes, i.e. a little under 5 kB per category which is derisory in terms of size.

These algorithms 87B, 87C allow near-instant evaluation of classification on current computer devices.

In one embodiment, the data analysis performed by the classification algorithm 87C is very simple and is formed solely of word detection and logic combinations of detected words.

In other words, the classification algorithm 87C comprises classification rules, each classification rule being associated with one from among the plurality of N categories, and each classification rule comprising at least one logic sequence intended selectively to associate at least one determined key-element with a given category

If a key-element such as “goal”, “striker” and “corner” in the preceding example occurs M times in a set of several classification rules determined during previous iterations, e.g. the classification rules corresponding to a given category, M being an integer of 2 or higher, preferably being 3 or 4, then this key-element is withdrawn from the learning data 87A received and stored in the second memory 58.

In other words, when the number of inclusions M of the key-element in a set of several classification rules determined during previous iterations is 2 or higher, preferably 3 or 4, then the key-element is withdrawn from the learning data 87A stored in the second memory 58 i.e. from the dictionary used for learning classification rules.

This makes it possible to guarantee that this key-element will not occur in the following classification rules, thereby obtaining a wider diversity of classification rules. The withdrawal of a key-element occurring too often therefore allows the classification algorithm obtained 87C to be improved upon.

Finally, each classification rule is evaluated from test samples for each category, and the evaluation is weighted as a function of the number of test samples in each category. With this weighting it is possible to obtain an evaluation which does not depend on the number of test samples in each category. The classification algorithm 87C can then be given uniform evaluation from one category to another irrespective of the number of test samples in each category.

Once this definition phase of the classification algorithm 87C has been completed, the classification algorithm 87C is executed via the second processor 56.

The classification algorithm 87C, as input data, then has the personal information 82 to be classified, received simultaneously or successively by the third device 18 and stored in the second memory 58.

The classification algorithm 87C therefore determines whether each item of personal information 82 comes under one of the categories cat1_{CL1}, cat2_{CL1} . . . catN_{CL1}, and if so the classification algorithm 87C determines this category with which one or more personalization parameters 85 are associated.

At this computing step 100 of the personalization parameters 85, the user's personal information 82 is still stored in the memory 58 of the third device 18 and is not transmitted outside the third electronic device 18, providing better security for the user's personal data.

The personalization parameters 85 computed at step 100 are than transmitted at step 110 by the transmission software 80 to the second electronic device 14.

The personalization parameters 85 are transmitted to the second device 14 without any transmission of the personalization parameters 85 via the Internet network 24. In other words, the personalization parameters 85 are not transmitted outside the local network 23 in the example of embodiment in FIG. 1. This also makes it possible to offer greater security for the user's personal information, the personalization parameters 85 being associated and computed on the basis of the said personal information 82.

The selecting means 70, at step 120, then select the data to be reproduced in relation to the previously computed personalization parameters 85.

The selected data relate for example to an electronic television program guide so as to present the user only with television programs corresponding to the user's personal information.

Alternatively or in addition, the selected data relate to audio and/or video files from among a global list of audio and/or video files stored locally in the storage device 21 or else in the database 60 of the management server 26 connected to the Internet network 24.

The personalization parameters 85 define a user profile for example, the profile comprising N weighting coefficients, each weighting coefficient being associated with a respective category from among the N predetermined categories of the classification CL1. The sum of the N weighting coefficients equals 1.

The selected data are for example the files from among the global list of audio and/or video files which correspond to a given category, such as the category corresponding to the highest weighting coefficient for the user profile under consideration.

Alternatively, the selected data are files from among the global list of audio and/or video files which correspond to a predetermined number of categories, such as the categories corresponding to the highest weighting coefficients for the user profile under consideration. The predetermined number of categories for data selection is 3 for example. The selected data are intended to be displayed per category on the first device 12, with priority display of the data in the category corresponding to the highest weighting coefficient.

Alternatively, the data are selected from among the global list of audio and/or video files so as to correspond to the N weighting coefficients of the user profile. In other words, the number of files selected for each respective category will be equal to the weighting coefficient associated with the category, multiplied by the total number of selected files from among the global list for all the N categories. If the weighting coefficient for the first category is 0.2 for example, then the number of selected files for this first category will be 0.2 times the total number of files selected from the global list for all the N categories. The total number of selected files is a predetermined number, whose value is initially chosen by the user for example. The selected data then correspond to a mix of files derived from the global list for all the categories, whilst corresponding to the user profile under consideration.

The selecting of files from a given category may be random for example. Alternatively, the files comprising data including one or more key-elements identified when determining the classification algorithm 87C are preferably selected for a given category, being given priority over files not comprising any key-element.

The selected data or files are television programs for example derived from the electronic television program guide and/or on-demand files such as Video On Demand, and/or software applications derived from an online store (AppStore), and/or video games.

The classification CL1 comprises the N=10 following categories for example: <<cars>>, <<electronics>>, <<fashion>>, <<finance>>, <<cooking>>, <<games>>, <<films>>, <<music>>, <<sport>> and <<travel>>.

The previously selected data to be reproduced are then transmitted to the first electronic device 12 at step 130 for reproduction thereof on the first electronic device 12.

The selected data are finally reproduced at step 140 by means of the video 32 and/or audio 36 reproduction means.

The electronic system 10 and the method for selecting audio and/or video data according to the invention thereby allow a user to be offered audio and/or video data which best correspond to the user's own personal tastes, whilst offering the best security for the user's personal information 82 which allowed this selection of audio and/or video data to be made.

The personalization parameters 85 computed from the personal information 82 are effectively only transmitted to the second device 14 and are not transmitted on the Internet network 24.

In addition, in the described embodiment, the personal information 82 is always stored in the memory 58 of the third device 18 and the personalization parameters 85 are computed directly by the computing means 84 integrated in the third device 18, which means that the user's personal information 82 permanently remains inside the third device 18. The personal information 82 is therefore never transmitted outside the third device 18 and even less so on the Internet network 24.

In addition, the personal information 82 is encrypted via the data securing means 86 to offer even better security for the user's personal information 82.

The second device 14, on the basis of the personalization parameters 85 received from the third device 18 and from its selection means 70, then selects the audio and/or video data corresponding to the user's personal information 82 i.e. corresponding to the user's tastes, whilst not making any transmission of the personalization parameters 85 over the Internet network 24.

Only selected audio and/or video data are able to be downloaded from the management server 26 via the Internet network 24, in the event that the selected audio and/or video data are contained in the database 60 of the said management server.

If the audio and/or video data are contained in the storage device 21, no data is transmitted via the Internet network 24 for the selection and reproduction of the said audio and/or video data. In other words, if the data to be reproduced are contained in the storage device 21, all data exchanges take place inside the local network 23.

It can therefore be appreciated that the electronic system 10 of the invention allows an improvement in the selection of data to be reproduced by the first device 12, whilst offering better security for the user's personal information 82 associated with this selection.

While the foregoing is directed to embodiments of the present invention, other and further embodiments of the invention may be devised without departing from the basic scope thereof, and the scope thereof is determined by the claims that follow.

What is claimed is:

1. An electronic system, comprising:
a first electronic device, the first electronic device comprising means for reproducing audio and/or video data;
a second electronic device, the second electronic device being connected to the first electronic device via a first data link, and comprising transmission means to transmits data to be reproduced to the first device;
a third electronic device, the third electronic device being connected to the second electronic device via a second data link, and comprising a memory capable of storing personal information associated with a user of the third device,
wherein the third electronic device further comprises means for computing personalization parameters of the data to be reproduced, from the personal information, and means to transmit the computed personalization parameters to the second electronic device, without any transmission of the personalization parameters via the Internet network, and
in that the second electronic device further comprises means for selecting data to be reproduced in relation to the personalization parameters received from the third electronic device, the selecting means being connected to the transmission means to transmit the selected data to be reproduced to the first device.

2. The electronic system according to claim 1, wherein the third electronic device further comprises means for securing the user's personal information in the memory of the third device.

3. The electronic system according to claim 1, wherein the user's personal information is stored in the memory of the third device, and is not transmitted outside the third electronic device.

4. The electronic system according to claim 1, wherein the data to be reproduced comprise elements of a man-machine interface, preferably stored in a memory of the second electronic device, without any transmission of the said elements of the man-machine interface via the Internet network.

5. The electronic system according to claim 1, wherein the selecting means are able to select data relating to an electronic television program guide so as only to present the user with television programs related to the user's personal information.

6. The electronic system according to claim 1, wherein the electronic system comprises an electronic appliance comprising a box, and wherein the first electronic device and the second electronic device are grouped together in the box of the electronic appliance.

7. The electronic system according to claim 1, wherein the third electronic device is a mobile telephone, preferably a smartphone.

8. The electronic system according to claim 1, wherein the first electronic device is a television and the second electronic device is a set-top box.

9. A local data transmission network, comprising an electronic system according to claim 1,
wherein each of the first and second data links is a wire or wireless short-distance communication link, such as a link having a length of less than 100 meters, and
wherein the transmission means are able to send the computed personalization parameters to the second electronic device without any transmission of the personalization parameters outside the local network.

10. The local network according to claim 9, wherein the short-distance wireless link is a link chosen from the group consisting of: a wireless link conforming to standard IEEE 802.11, a wireless link based on standard IEEE 802.15.1, and a wireless link conforming to standard IEEE 802.15.4.

11. A method for selecting audio and/or video data to be reproduced on a first electronic device comprising means for reproducing audio and/or video data, the method comprising the following steps:
selecting data, via a second electronic device, to be reproduced on the first electronic device,
transmitting the selected data to the first device for reproduction thereof by the first device,
wherein the method further comprises the following steps:
computing, via a third electronic device, personalization parameters of data to be reproduced on the basis of a user's personal information, the said personal information being stored in a memory of the third device, and
transmitting the computed personalization parameters to the second electronic device, without any transmission of the personalization parameters via the Internet network,
the selection of data to be reproduced being performed in relation to the personalization parameters received from the third electronic device.
